(19) United States
(12) Patent Application Publication
(10) Pub. No.: US 2006/0275647 A1
(43) Pub. Date: Dec. 7, 2006

(54) Textile derived solid oxide fuel cell system

(76) Inventors: Caine Finnerty, Buffalo, NY (US); Glenn Spacht, Lloyd Neck, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 11/146,637

(22) Filed: Jun. 6, 2005

(51) Int. Cl. H01M 4/86; H01M 8/06; B29C 65/00; B29C 44/04; H01M 4/88

(52) U.S. Cl. 429/40; 429/19; 429/45; 264/42; 264/45.1; 502/101

(57) ABSTRACT

The present invention provides a novel article of manufacture, which includes a structure having at least two surfaces and a plurality of void passages. The present invention also provides a method of making an article of manufacture that includes a structure having at least one void passage, and the article of manufacture produced therewith, including (a) coating a pre-form with a coating composition; and (b) destructively removing the pre-form thereby producing the structure with the at least one void passage. Further provided is a method of making a fuel cell electrode, and a fuel cell containing the electrode produced therewith.

### FIELD OF THE INVENTION

The present invention relates generally to a method of making a novel article of manufacture (e.g., a fuel cell electrode), and the article of manufacture produced therewith, which contains a structure having at least one void passage. The present invention also relates generally to a fuel cell system including the article of manufacture.

### BACKGROUND OF THE INVENTION

A fuel cell is a device which converts the energy potential of a fuel to electricity through an electrochemical reaction. In general, a fuel cell includes a pair of electrodes separated by an electrolyte. The electrolyte only allows the passage of certain types of ions. The selective passage of ions across the electrolyte results in a potential being generated between the two electrodes. This potential can be harnessed to perform useful work, such as powering a motor vehicle or home electronics. This direct conversion process increases the efficiency of power generation by removing mechanical steps required by traditional power generating device, such as turbine plants. Additionally, the combination of higher efficiency and electrochemical processes makes a fuel cell system an environment-friendly power generator.

A solid oxide fuel cell (“SOFC”) is a device that is approximately 40% efficient in converting the energy potential of a fuel to electricity through an electrochemical reaction. A SOFC possesses three basic parts: an anode that produces electrons, a cathode that consumes electrons, and an electrolyte that conducts ions but prevents electrons from passing. The SOFC generally runs on a mixture of hydrogen and carbon monoxide formed by internally reforming a hydrocarbon fuel (e.g. propane, methane, and diesel) while using air as the oxidant. A SOFC system generates a larger amount of electricity per pound of weight than competitive fuel cell systems, such as systems incorporating proton exchange membrane fuel cells.

There are two general types of SOFC, tubular cells and planar cells, in referring to the shape of their respective fuel cells which are shaped as cylinders as or plates, respectively. A SOFC operates at relatively high temperatures, around 850-1000° C. As a result of the high operating temperatures, the fuel cells suffer from difficulties with sealing around the ceramic parts of the cells. Furthermore, the high operating temperature of a SOFC demands a longer start-up time in comparison to that of a proton exchange membrane fuel cell which operates in a temperature below 100° C. In the past, this has made SOFC system a less suitable option for applications that require near instantaneous power.

Thus, there exists a need for an improved fuel cell system that is capable of rapidly reaching, and subsequently maintaining, a high temperature suitable for the operation of the fuel cell system, and that generates low internal thermal stresses and accordingly has reduced sealing requirements.

### SUMMARY OF THE INVENTION

The present invention provides an article of manufacture, which includes a structure having at least two surfaces and a plurality of void passages, where (a) each of the plurality of void passages may have a first end and a second end and each of the ends communicates with a different surface thereby providing a conduit between the two surfaces; (b) at least one of the plurality of void passages provides a conduit that essentially does not communicate with a conduit provided by another of the plurality of void passages; (c) at least one of the plurality of void passages provides a conduit that has a direction that deviates from a straight direction at at least one point along a length of the conduit; and (d) the section of the article of manufacture between the plurality of void passages is substantially occupied by solid materials. In one embodiment, the structure may be made of a ceramic material. In another embodiment, the structure may contain a catalyst.

The present invention also provides a method of making an article of manufacture that includes a structure having at least one void passage, and the article of manufacture produced therewith, including (a) coating a pre-form (e.g., a textile or a foam) with a coating composition; and (b) destructively removing the pre-form (e.g., by sintering) thereby producing the article of manufacture. The coating composition may contain a number of functional compositions, such as a cermet and a catalyst.

The present invention further provides a method of making a fuel cell electrode (e.g., an anode or a cathode), and a fuel cell containing the electrode produced therewith, including: (a) coating a pre-form (e.g., a textile or a foam) with an electrode composition; and (b) destructively removing the pre-form (e.g., by sintering) thereby producing the fuel cell electrode. The electrode composition may contain a number of functional compositions, such as a cermet, a metal (e.g., nickel), and a catalyst. The electrode may be coated with a plurality of different electrode compositions which give the electrode a layered structure. The electrode may further contain a high surface area coating and a catalyst which is capable of catalyzing the combustion and/or partial oxidation of a fuel (e.g., a reformer catalyst).

Additional aspects of the present invention will be apparent in view of the description that follows.

### BRIEF DESCRIPTION OF THE FIGURES

FIG. 1 depicts a representative fuel cell system according to one embodiment of the invention. A central support tube (2) is inserted into a fuel cell stack (1) comprising of multiple fuel cells (3), a fuel cell plate (4), a current collection plate (5), and a manifold (6). The fuel cell plate (4) is affixed to the central support tube (2) by physical, mechanical, and/or chemical means, such as friction.

FIG. 2 illustrates a textile pre-form (7) according to one embodiment of the invention partially submerged in a slurry (8) contained in a container (9) during the process of dipping and coating the pre-form (7) in the slurry (8).

FIG. 3 shows three closely spaced pre-forms (10) according to one embodiment of the invention partially submerged in a slurry (8) contained in a container (9) during the process of dipping and coating the pre-form (10) in the slurry (8).

FIG. 4 shows a fuel cell complex anode (11) according to one embodiment of the invention including multiple passages (10) formed by sintering closely spaced pre-forms (7) after coating, as shown in FIG. 3.

FIG. 5 depicts a placement fixture (12) according to one embodiment of the invention, which incorporates fiber positioning features (14) to control the location of the individual textile pre-forms (7) as well a depth control features (15), with five pre-forms (7) that are about to be placed in a slurry (8) within a rectangular plate mold (13).

FIG. 6 illustrates a placement fixture (12) according to one embodiment of the invention with five pre-forms (7) partially submerged in a slurry (8) within a rectangular plate mold (13).

FIG. 7 shows a coated pre-form assembly (16) according to one embodiment of the invention with five exposed textile pre-forms (7) prior to the sintering and trimming processes.

FIG. 8 depicts a complex anode (17) according to one embodiment of the invention with five fuel passages (18) after the sintering and trimming processes.

FIG. 9 shows an anode connector (19) according to one embodiment of the invention formed in conjunction with the formation of the complex anode (17).

FIG. 10 illustrates a complex fuel cell (22) according to one embodiment of the invention in which the ends of the complex anode (17) and the end of the anode connector (19) have been masked during the application of the electrolyte and cathode (20).

FIG. 11 depicts three fuel cell complexes (22) according to one embodiment of the invention assembled to form a stack (21) by placing their respective anode connectors (19) in contact with the adjacent complex's cathode (20).

FIG. 12 depicts an article of manufacture (23) according to one embodiment of the invention including a solid structure having at least two surfaces (24 and 25) and a plurality of void passages (26), where (a) each of the plurality of void passages may have at least a first end (27) and a second end (28) and each of the ends (27 and 28) communicates with a different surface (24 or 25) thereby providing a conduit between the two surfaces; (b) at least one of the plurality of void passages provides a conduit that essentially does not communicate with a conduit provided by another of the plurality of void passages; (c) at least one of the plurality of void passages provides a conduit that has a direction that deviates from a straight direction at at least one point along a length of the conduit; and (d) the section (29) of the article of manufacture between the plurality of void passages is substantially occupied by solid materials.

### DETAILED DESCRIPTION OF THE INVENTION

As used herein and in the appended claims, the singular forms “a,” “an,” and “the” include plural references unless the content clearly dictates otherwise. Thus, for example, reference to “a catalyst” includes a plurality of such catalysts and equivalents thereof known to those skilled in the art, and reference to “the fuel cell” is a reference to one or more fuel cells and equivalents thereof known to those skilled in the art, and so forth. All publications, patent applications, patents, and other references mentioned herein are incorporated by reference in their entirety.

The present invention generally provides a method for producing an article of manufacture, e.g., a solid article, and the article produced therewith, which may be utilized in a wide variety of fields, for instance, as a fuel cell electrode, a reformer for a fuel cell system, a catalyst carrier for processing chemicals or waste, and a structural component in a system. The present invention also provides a fuel cell and a fuel cell system containing at least one electrode produced therewith. A fuel cell produced using the method of the present invention may have at least one desirable features, such as, enhanced fuel efficiency, improved energy output, less stringent sealing requirement, shorter start-up time, and high adaptability because the fuel cell may be shaped according to the specific demand of a particular device/application (e.g., a fuel cell in the shape of a straight rod, a curved rod, a rectangular card, a coil, or an irregular form).

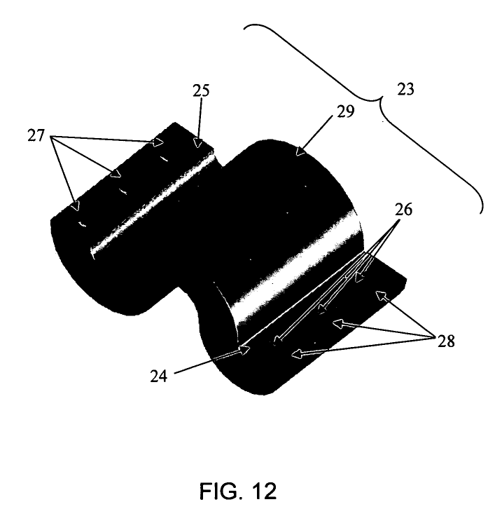

In one aspect, as shown in FIG. 12, the present invention provides an article of manufacture (23), which includes a structure having at least two surfaces (24 and 25) and a plurality of void passages (26), where (a) each of the plurality of void passages may have at least a first end (27) and a second end (28) and each of the ends (27 and 28) communicates with a different surface (24 or 25) thereby providing a conduit between the two surfaces; (b) at least one of the plurality of void passages provides a conduit that essentially does not communicate with a conduit provided by another of the plurality of void passages; (c) at least one of the plurality of void passages provides a conduit that has a direction that deviates from a straight direction at at least one point along a length of the conduit; and (d) the section (29) of the article of manufacture between the plurality of void passages is substantially occupied by solid materials. A space filled by a porous material, such as, a ceramic material, a foam, or a collection of fibers, is deemed as a space substantially occupied by solid materials for the purpose of the present invention.

The article of manufacture may be made of any material suitable for the purpose of the intended application, such as, without limitation, a ceramic material, a polymer, a composite, a metal, an alloy, a glass, a plastic, and derivatives, mixtures, and combinations thereof. One of the advantages of the article of the present invention is that it may be shaped according to the specific demand of a particular device/application, such as, without limitation, in the shape of a straight rod, a curved rod, a rectangular block, a coil, and an irregular form, while still providing passages, conduits, and communications between the faces of the solid article, which makes it suitable for a plethora of applications. For example, an article of the present invention may be fabricated into a shape that fully utilizes the space of a device, such as a portable device, and may enable the manufacturing of a more compact device (e.g., a MP3 player, a flat screen TV, or a detector) without sacrificing its functionality. In one embodiment, the solid article of the present invention may further contain a high surface area coating, such as a coating formed by calcining a mixture of alpha-alumina and gamma-alumina. Materials for forming high surface area coatings are known in the art.

The article of manufacture of the present invention may serve as a carrier, or a support, for a catalyst composition, such as, a fuel cell catalyst, a reforming catalyst, a waste (e.g., an automobile waster gas) processing catalyst, a chemical processing catalyst, or an enzyme. The catalyst may be distributed evenly or randomly in the article. In one embodiment, the catalyst may be functionally incorporated into the surface of at least one of the plurality of void passages. The term “functionally incorporated into the surface of a void passage,” as used herein and in the appended claims, refers to a catalyst which is located in a position that enables it to have substantially access to its substrate, which is generally passing through the passage during an operation, and to function substantially similar to a catalyst which is located on the surface of the passage. For example, when a ceramic material is used, a catalyst which is located substantially away from the surface of a passage may still be deemed as functionally incorporated into the surface of that passage because the substrate/reactant may reach the catalyst and the product of the reaction may return to the passage through diffusion.

The present invention also provides a method for producing an article of manufacture which includes a structure having at least one void passage, and the article produced therewith, which method includes (a) coating a pre-form with a coating composition; and (b) destructively removing the pre-form thereby producing the at least one void passage in the structure. The term “pre-form,” as used herein and in the appended claims, refers to a substrate, a support, or a solid object, made of any suitable materials, where it is capable of being coated with a coating composition and destructively removed from the coating composition, such as a textile or a porous material (e.g., a polymer foam). The term “destructively removing,” as used herein and in the appended claims, refers to any technique (e.g., a physical technique, a chemical technique, or the combination thereof) known in the art which is capable of removing a substrate material and rendering the substrate material non-reusable (e.g., by decomposing) while without causing substantial damage to the resulting solid article. A pre-form is “destructively removed” where it is not available for re-use in the process. For example, a ceramic solid article may be produced by coating a textile pre-form with a slurry of cermet. The textile pre-form may be destructively removed by subject the coated textile pre-form to a temperature high enough to cause the decomposition of the textile pre-form (e.g., by sintering). In another example, a solid article may be produced by coating a polymer foam pre-form with a coating composition. After the coated foam pre-form is dried or sets, it is subjected to an organic solvent which dissolves the polymer foam and thus destructively removing the pre-form from the dried coating composition. The dried coating composition resulted may be further processed to produce the article of manufacture.

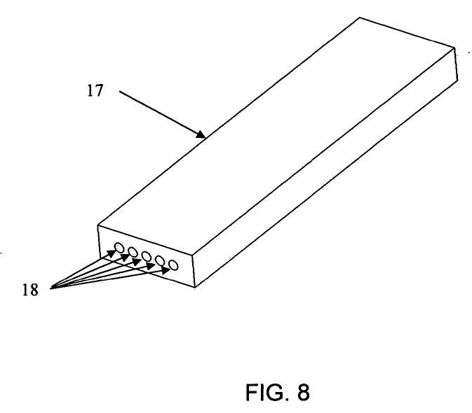

In one embodiment, the pre-form of the present invention is a textile pre-form. The term “textile,” as used herein and in the appended claims, includes any woven, knitted, knotted, tufted, tied, or unwoven fiber or fabric materials, such as, without limitation, a natural fiber, a semi-synthetic fiber, a synthetic fiber, a plurality of interweaving and/or interconnected fibers (e.g., a strand, a strip, a cloth, and a block), a single unwoven fiber, and a branched thread or yarn. In one embodiment, the textile pre-form or a plurality of textile pre-forms may be arranged in accordance with a pre-determined pattern, either before or after the coating process. For instance, an article with a structure having a plurality of parallel placed, evenly spaced void passages, such as the anode of FIG. 8, may be produced in accordance with the present invention, where a plurality of textile pre-forms are placed in a evenly spaced, parallel fashion before the coating process and the pattern is maintained through the coating process. Depending on the purpose of a particular application, the textile pre-form may be arranged into a regular pattern (e.g., a straight line, a coil, a plane, a block, or an array) or an irregular pattern.

The coating composition may contain any materials suitable for making the article of purpose, including, without limitation, a metal, a polymer, an inorganic compound, a cermet, a fine particle of a high surface area material, a catalyst, a dispersant, and a solvent. The coating composition may be coated onto a pre-form using any suitable techniques known in the art, such as, without limitation, impregnation, printing, spray-coating, deposition, molding, or brushing. In one embodiment, the coating composition may contain a catalyst, e.g., a reforming catalyst, which is functionally incorporated into the surface of a void passage.

For certain applications, it may be desirable to produce an article with a layered structure, such as a fuel cell electrode with one layer having high content of a catalyst and another layer having high content of ceramic supporting material. Such solid article may be produced by coating a pre-form with a plurality of identical or different coating compositions and then destructively remove the pre-form. It may also be obtained by (a) coating a pre-form with a first coating composition; (b) destructively remove the pre-form; and (c) coating the resulting solid object with a second coating composition (or a plurality of difference coating composition as commanded by the particular application) and processing the coated solid object to produce the solid article. For example, a solid structure may be produced by sintering a cermet coated textile pre-form. The solid structure may subsequently be subjected to a wash-coat process where it is coated with a high surface area coating material, such as gamma-alumina and a mixture of gamma-alumina and alpha-alumina. Method for wash-coating a solid structure is disclosed in U.S. patent application: Method for Producing High Performance Catalyst (Atty. Docket No. 6612-37), which is hereby incorporated herein by reference in its entirety. The coated solid object may be calcined to produce an article having a high surface area. A significantly increased amount of catalyst or other active species may be deposited onto this article. In another example, a pre-form (e.g., a textile pre-form) may be coated first with a catalyst coating composition and the catalyst-containing pre-form may then be coated with a cermet coating composition.

The present invention further provides a method for making a fuel cell electrode (e.g., an anode or a cathode), and a fuel cell containing the fuel cell electrode produced therewith, including: (a) coating a pre-form with an electrode composition; and (b) destructively removing the pre-form thereby producing an electrode with at least one void passage in the electrode.

In one embodiment, the pre-form may be a textile pre-form. In another embodiment, the pre-form may be arranged in accordance with a pre-determined pattern. In yet another embodiment, the pre-form may be a pre-form made of a porous material (e.g., a polymer foam). Depending on the purpose of a particular application, the pre-form may be arranged into a regular pattern (e.g., a straight line, a coil, a plane, a block, or an array) or an irregular pattern as commanded by the particular application.

The electrode composition of the present invention may be any material suitable for producing a fuel cell electrode, which are well known in the art, such as a slurry of cermet. Generally, at least a substantial portion of an electrode composition may be a heat-stable material or a material which may be converted to a heat-stable material using the process of the present invention. A material is heat-stable for the purpose of the present invention when the material (a) is capable of substantially accomplishing its intended purpose at a temperature generally suitable for the operation of a fuel cell and (b) essentially is not destroyed or irreversibly destroyed under such condition for a reasonable period of time. For example, an electrode composition may contain a material selected from the group consisting of nickel, yttria-stabilized zirconia (“YSZ”), and a mixture of nickel and YSZ. An electrode composition may further contain a plurality of supplement compositions, such as a reforming catalyst, a combustion catalyst, a dispersant, a solvent (e.g., water or an organic solvent). For example, the addition of metal dopents (e.g., precious metals) and/or active oxides (e.g., ceria) to an electrode composition before the sintering step may improve the performance of the electrode produced. In another example, the addition of materials, such as molybdenum, tungsten, lithium, and/or potassium to the electrode composition may help to reduce carbon deposition during the operation of the fuel cell electrode.

The fuel cell electrode of the present invention may have a single layer structure or a multi-layered structure. For example, a fuel cell electrode with three different layers may be formed following the method of the present invention by coating a pre-form with three different coating compositions. In addition, a fuel cell electrode may be formed in such a manner that even in a single layer, the structure in one section of the electrode may be different from that of another section of the electrode. For example, a pre-form may be divided into a plurality of sections and each section may be independently coated with a different electrode composition. It may also be desirable to coat a fuel cell electrode with a high surface area coating material (e.g., gamma-alumina and alpha-alumina), which generally may improve the efficiency of the fuel cell and optionally provides other benefits, such as, having a short start-up time when the high surface area coating material contains a reforming and/or a combustion catalyst (e.g., a metal selected from a group including platinum, palladium, rhodium, ruthenium, and iridium).

Also provided are a fuel cell having the fuel cell electrode of the present invention and a fuel cell system having such fuel cells.

### EXAMPLES

The following examples illustrate the present invention, which are set forth to aid in the understanding of the invention, and should not be construed to limit in any way the scope of the invention as defined in the claims which follow thereafter.

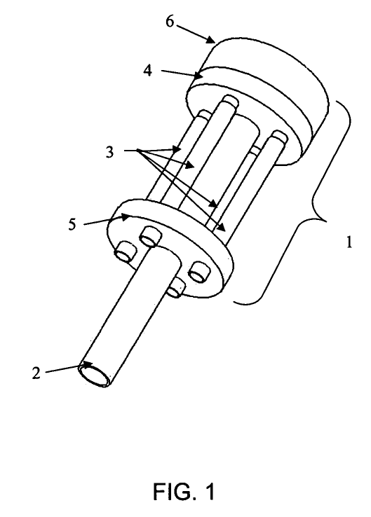

A fuel cell system is disclosed, as well as the method to construct the system, which offers many of the advantages of a tubular SOFC system as well as other benefits, such as, enhanced fuel efficiency and short start-up time. A typical tubular fuel cell stack (1), such as, those disclosed in U.S. patent application Ser. No. 10/939,185 which is hereby incorporated herein by reference in its entirety, is illustrated in FIG. 1. The multiple fuel cells (3) which are assembled into the stack are traditionally fabricated using standard ceramic fabrication techniques, such as extrusion which results in tubes having a constant cross section through out the length of the fuel cell (3) and rather limited interior surface area. The inventors disclose a method for fabricating a fuel cell that increases the interior surface area of the cell thereby affording the opportunity for increased electrochemical activity. While the following examples focus on anode supported fuel cells, the technology is equally applicable to cathode supported fuel cells.

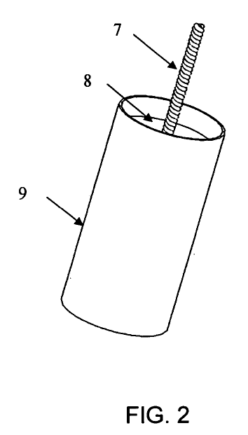

As shown in FIG. 2, a fuel cell was formed by dipping a textile pre-from (7) into an anode slurry (8), drying the resulting coated textile, and then sintering the assembly at a temperature of 1000° C. or higher. The length of a cell may be adjusted by trimming the cell either prior to or subsequent to the sintering process. During the sintering process, the pre-form decomposes leaving behind a structure having a void passage with a shape resembling that of the textile pre-from. The resulting fuel cell has a large surface area, which may be two magnitudes larger than the surface area of a fuel cell of a similar length fabricated with a conventional extrusion process. While FIG. 2 teaches coating the textile pre-form by means of dipping, other means of coating a textile pre-form, such as, spraying and vapor deposition, may also be used.

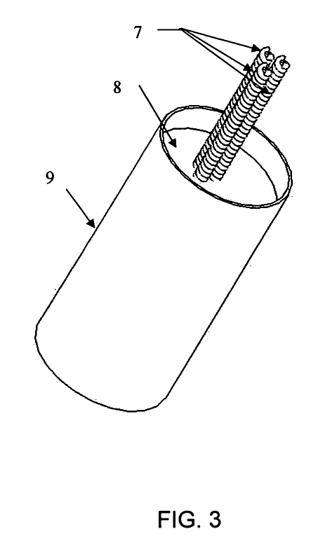

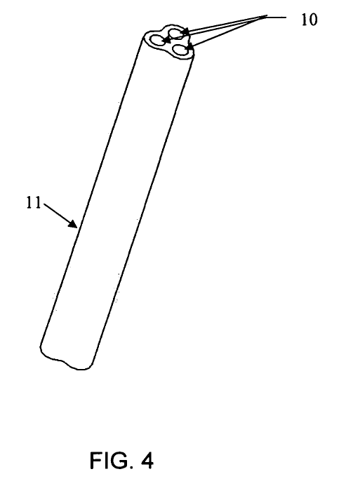

The method of the present invention also allows the fabrication of a fuel cell with more complex structures, such as the complex anode (11) having multiple fuel passages (10) as displayed in FIG. 4. As shown in FIG. 3, a group of three textile pre-forms (7) were dipped into a slurry (8) while the pre-forms were either precisely positioned by means of a locating fixture or imprecisely positioned relative to one another. The wet complex anode was then dried, sintered, and trimmed to a desired length. The resulting fuel cell generally has an irregular outer contour, which may create sealing difficulties for some applications. If desired, the fuel cell may be further processed to produce a fuel cell with a regular, smooth outer surface. Techniques for producing a smooth outer contour are known in the art, such as, casting, gel casting, and molding.

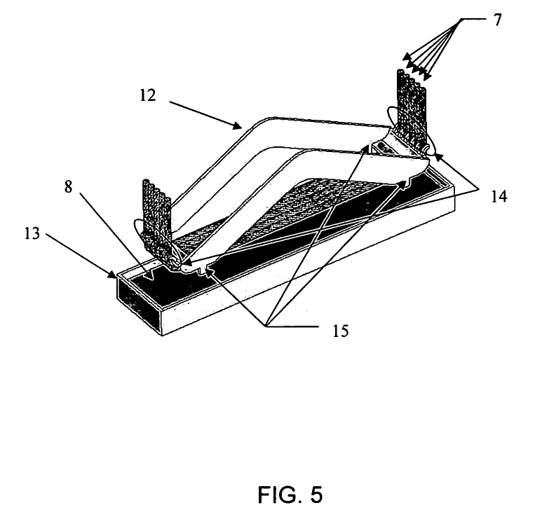

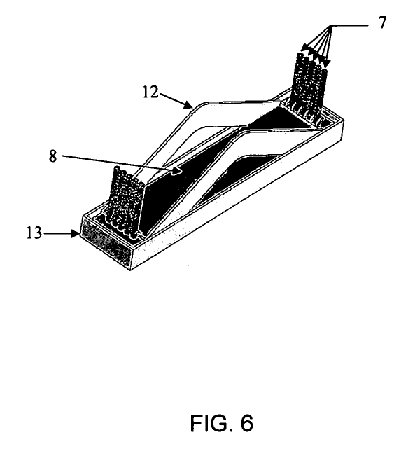

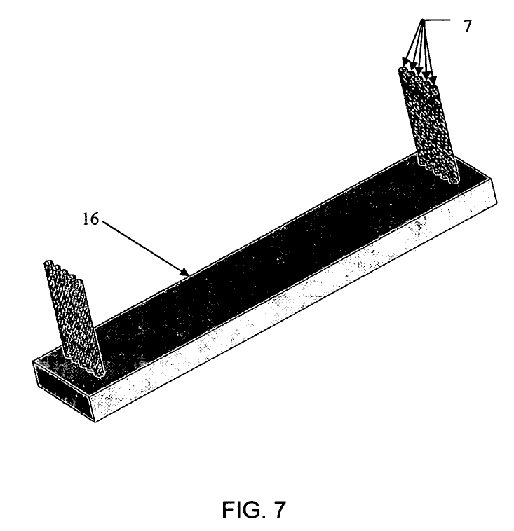

FIGS. 5-8 depicts a process for producing a planar complex anode with five fuel passages and regular, smooth outer contour. As shown in FIG. 5, five textile pre-forms (7) were positioned by means of a placement fixture (12) which incorporates a depth control features (15) and a fiber positioning feature (14) to control the location of the individual textile pre-forms (7). The placement fixture (12) may then be submerged in a slurry (8) contained in a mold (13) as shown in FIGS. 5 and 6. The molded assembly was then dried as shown in FIG. 7. The assembly was then sintered and trimmed as described in the previous paragraphs to produce a planar complex anode (17) with multiple fuel passages (18) as shown in FIG. 8.

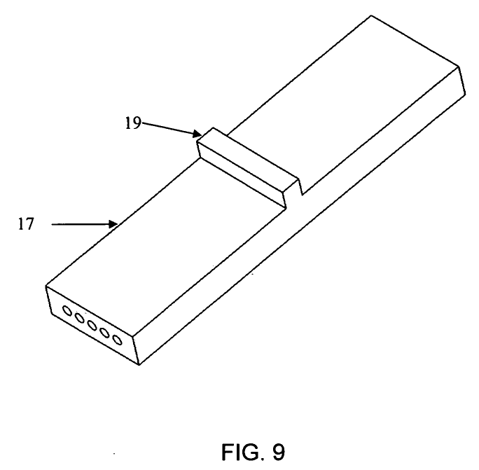

In order to create a functional fuel cell stack, the fuel cells must be electrically connected, either in parallel, in series, or in a combination thereof. The interconnection of complex anode-based fuel cells may be facilitated, as shown in FIG. 9, by the formation of one or more anode connectors (19) on the complex anode (17) during casting, such as, by merely providing a depression in the bottom of the mold (13) used to form the complex anode as previously discussed (see, e.g., FIGS. 5-6). The electrolyte layer (e.g., yttrium stabilized zirconia, scandium-doped zirconia, or ceria-based electrolyte) and the cathode layer were then applied to the complex anode. Standard application protocols may include spraying, dipping, or deposition. In the present examples, dipping was used to apply the electrolyte layer and the cathode layer to the complex anode (17).

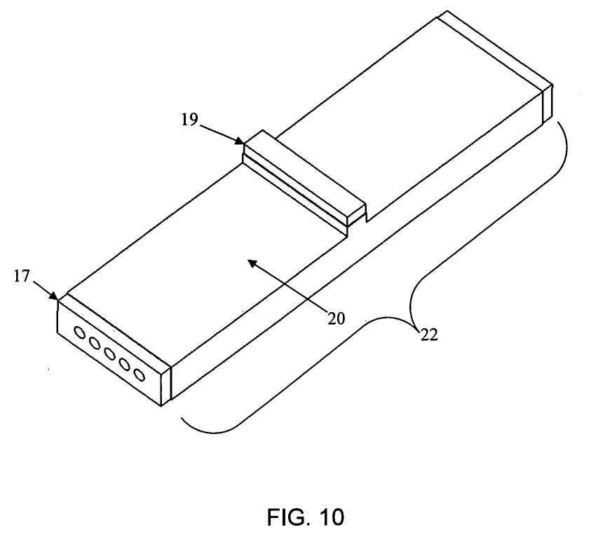

Prior to the application of the electrolyte and cathode, it may be necessary to mask the ends of the complex anode (17) as well as the exposed end of the anode connector (19) if the method of application of the electrolyte and the cathode are imprecise. Since dipping is one of the least precise forms of application, the ends of the complex anode (17) as well as the exposed end of the anode connector (19) were masked by dipping them in paraffin wax before the application of the electrolyte and the cathode layers. The masked complex anode was then dipped in a solution of electrolyte and subsequently sintered. The plate was then masked again before the cathode was applied. However, if the materials are compatible, it may be possible to apply the cathode composition to the dried electrolyte layer prior to sintering the electrolyte thereby saving one sintering and one masking step. The resulting complex fuel cell (22) fabricated by applying the electrolyte and the cathode (20) to a complex anode (17) is shown in FIG. 10.

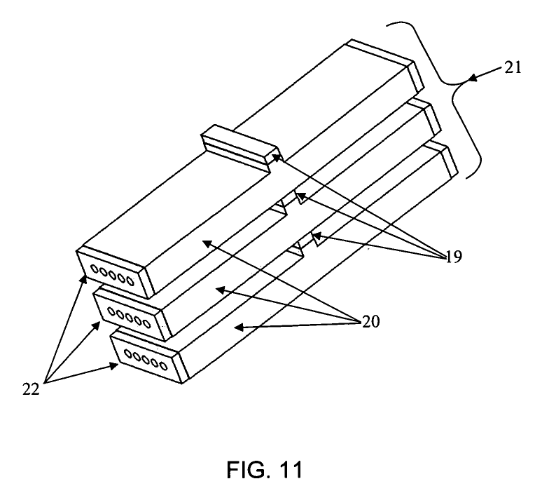

As shown in FIG. 11, a fuel cell stack (21) can be created by simply arranging one complex fuel cell (22) next to another. Under such arrangement, the anode connector (19) of one fuel cell is brought into contact with the cathode of the adjoining cell, creating a series connection. A mechanism, such as a compressive force, is required to maintain such contact as between the individual complex fuel cells as the system heats and cools during its operation. This force can be provided by any of a variety of clamping or spring arrangements commonly used with proton exchange membrane fuel cells.

Furthermore, solid oxide fuel cell systems may include integral catalytic heaters and reformers to heat the fuel cell system to operating temperature and convert a hydrocarbon fuel to hydrogen and carbon dioxide, which are consumed by the fuel cells to produce electricity. As shown in FIG. 1, a catalytic combustion heater and partial oxidation reformer, which is an open cell honeycomb wash-coated with high surface area metal oxides (e.g. gamma alumina) and impregnated with appropriate catalyst (e.g., platinum), is included in the central support (2). Method for preparing a honeycomb-based heater/reformer is disclosed in U.S. patent application: Method for Producing High Performance Catalyst (Atty. Docket No. 6612-37), which is hereby incorporated herein by reference in its entirety. A combustion heater catalyst and/or a partial oxidation reformer catalyst may also be directly functionally incorporated into the internal surface area of the textile derived solid oxide fuel cell. By embedding the heating/reforming catalyst within the fuel cell anode, the temperature of the fuel cell can be quickly raised to the required operating temperature thereby significantly reducing the start-up time. In one example, the combustion heater catalyst/a partial oxidation reformer catalyst has been shown to increase the temperature of the anode for as much as 900° C. within one minute of the initiation of the reaction.

A pre-form may also be subjected to a multiple rounds of coating process to create a multi-layer structure. In one example, the inventors have produced fuels cells using a gradient coating process, where multiple electrode compositions containing a mixture of nickel and yttria-stabilized zirconia (“YSZ”) were used to coat a textile pre-form and each electrode composition has a different nickel:YSZ ratio. The resulting fuel cells have a multi-layer structure with the inner layers having relatively higher nickel:YSZ ratios. The graded coating increases the extent of the three phase boundary of a fuel cell and thus enhancing the power production potential of the fuel cell. For example, fuel cells with short start-up time and high efficiency were produced by sequentially coating a textile pre-form with the following compositions: (1) a heating/reforming catalyst; (2) a low viscosity electrode composition containing a mixture of nickel and YSZ with a high nickel:YSZ ratio; (3) a low viscosity composition containing a mixture of nickel and YSZ with a moderate nickel:YSZ ratio; (4) a low viscosity composition containing a mixture of nickel and YSZ with a low nickel:YSZ ratio; (5) submicron size YSZ; and (6) a cathode composition (e.g. LSM or similar material).

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. An article of manufacture comprising a structure having at least two surfaces and a plurality of void passages wherein:
(a) each of the plurality of void passages comprises at least a first end and a second end and each of the ends communicates with a different surface thereby providing a conduit between the two surfaces;
(b) at least one of the plurality of void passages provides a conduit that essentially does not communicate with a conduit provided by another of the plurality of void passages;
(c) at least one of the plurality of void passages provides a conduit that has a direction that deviates from a straight direction at at least one point along a length of the conduit; and
(d) the section of the article of manufacture between the plurality of void passages is substantially occupied by solid materials.

2. The article of manufacture of claim 1, wherein the structure is made of a ceramic material.

3. The article of manufacture of claim 1, wherein the structure comprises a catalyst.

4. The article of manufacture of claim 3, wherein the catalyst is functionally incorporated into a surface of at least one of the plurality of void passages.

5. The article of manufacture of claim 1, wherein the structure comprises a high surface area coating.

6. An article of manufacture comprising a structure having at least one void passage obtained in accordance with a process comprising:
(a) coating a pre-form with a coating composition; and
(b) destructively removing the pre-form thereby producing the at least one void passage in the structure.

7. The article of manufacture of claim 6, wherein the pre-form comprises a textile.

8. The article of manufacture of claim 7, wherein the textile comprises at least one fiber selected from the group consisting of a natural fiber, a semi-synthetic fiber, and a synthetic fiber.

9. The article of manufacture of claim 7, wherein the textile is arranged in accordance with a pre-determined pattern.

10. The article of manufacture of claim 7, wherein the textile comprises a plurality of interweaving fibers.

11. The article of manufacture of claim 6, wherein the pre-form comprises a polymer material.

12. The article of manufacture of claim 6, wherein the coating composition comprises a cermet.

13. The article of manufacture of claim 6, wherein the coating composition comprises a catalyst.

14. The article of manufacture of claim 6, wherein the catalyst is functionally incorporated into a surface of the at least one void passage.

15. The article of manufacture of claim 6, further comprising coating the coated pre-form of step (a) with at least one other coating composition.

16. The article of manufacture of claim 6, further comprising coating the structure with at least one other coating composition.

17. The article of manufacture of claim 6, further comprises coating the structure with a high surface area coating material.

18. The article of manufacture of claim 17, wherein the high surface area coating material is selected from the group consisting of gamma-alumina and a mixture of gamma-alumina and alpha-alumina.

19. The article of manufacture of claim 17, wherein the high surface area coating material comprises a catalyst.

20. The article of manufacture of claim 6, further comprises coating the pre-form with a catalyst composition before the step (a).

21. A fuel cell comprising at least one electrode obtained in accordance with a process comprising:
(a) coating a pre-form with an electrode composition; and
(b) destructively removing the pre-form thereby producing an electrode with at least one void passage in the electrode.

22. The fuel cell of claim 21, wherein the at least one electrode is at least one of anode and cathode.

23. The fuel cell of claim 21, wherein the pre-form comprises a textile.

24. The fuel cell of claim 23, wherein the textile comprises at least one fiber selected from the group consisting of a natural fiber, a semi-synthetic fiber, and a synthetic fiber.

25. The fuel cell of claim 23, wherein the textile is arranged in accordance with a pre-determined pattern.

26. The fuel cell of claim 23, wherein the textile comprises a plurality of interweaving fibers.

27. The fuel cell of claim 21, wherein the pre-form comprises a polymer material.

28. The fuel cell of claim 21, wherein the electrode composition comprises a cermet.

29. The fuel cell of claim 21, wherein the electrode composition comprises at least one selected from the group consisting of nickel, yttria-stabilized zirconia (“YSZ”), and a mixture of nickel and YSZ.

30. The fuel cell of claim 21, wherein the electrode composition further comprises a reforming catalyst.

31. The fuel cell of claim 21, further comprising coating the coated pre-form of step (a) with at least one other electrode composition.

32. The fuel cell of claim 31, wherein both the electrode composition and the at least one other electrode composition comprise a mixture of nickel and YSZ and wherein the content of YSZ of the at least one other electrode composition is higher than that of the electrode composition.

33. The fuel cell of claim 21, further comprising coating the electrode with at least one other electrode composition.

34. The fuel cell of claim 33, wherein both the electrode composition and the at least one other electrode composition comprise a mixture of nickel and YSZ and wherein the content of YSZ of the at least one other electrode composition is higher than that of the electrode composition.

35. The fuel cell of claim 21, further comprises coating the electrode with a high surface area coating material.

36. The fuel cell of claim 35, wherein the high surface area coating material is selected from the group consisting of gamma-alumina and a mixture of gamma-alumina and alpha-alumina.

37. The fuel cell of claim 35, wherein the high surface area coating material comprises a catalyst.

38. The fuel cell of claim 37, wherein the catalyst comprises a metal selected from the group consisting of platinum, palladium, rhodium, ruthenium, and iridium.

39. The fuel cell of claim 21, further comprises coating the pre-form with a catalyst composition before the step (a), wherein the catalyst composition catalyzes partial oxidation of a fuel.

40. The fuel cell of claim 21, further comprises coating the pre-form with a catalyst composition before the step (a), wherein the catalyst composition catalyzes combustion of a fuel.

41. A fuel cell system comprising the fuel cell of claim 21.

42. A method of making an article of manufacture comprising a structure having at least one void passage comprising:
(a) coating a pre-form with a coating composition; and
(b) destructively removing the pre-form thereby producing the at least one void passage in the structure

43. The method of claim 42, wherein the pre-form comprises a textile.

44. The method of claim 43, wherein the textile comprises at least one fiber selected from the group consisting of a natural fiber, a semi-synthetic fiber, and a synthetic fiber.

45. The method of claim 43, wherein the textile is arranged in accordance with a pre-determined pattern.

46. The method of claim 43, wherein the textile comprises a plurality of interweaving fibers.

47. The method of claim 42, wherein the pre-form comprises a polymer material.

48. The method of claim 42, wherein the coating composition comprises a cermet.

49. The method of claim 42, wherein the coating composition comprises a catalyst.

50. The method of claim 49, wherein the catalyst is functionally incorporated into the at least one void passage.

51. The method of claim 42, further comprising coating the coated pre-form of step (a) with at least one other coating composition.

52. The method of claim 42, further comprising coating the structure with at least one other coating composition.

53. The method of claim 42, further comprises coating the structure with a high surface area coating material.

54. The method of claim 53, wherein the high surface area coating material is selected from the group consisting of gamma-alumina and a mixture of gamma-alumina and alpha-alumina.

55. The method of claim 53, wherein the high surface area coating material comprises a catalyst.

56. The method of claim 42, further comprises coating the pre-form with a catalyst composition before the step (a).

57. A method for making a fuel cell electrode comprising:
(a) coating a pre-form with an electrode composition; and
(b) destructively removing the pre-form thereby producing an electrode with at least one void passage in the electrode.

58. The method of claim 57, wherein the fuel cell electrode is one of anode and cathode.

59. The fuel cell of claim 57, wherein the pre-form comprises a textile.

60. The method of claim 59, wherein the textile comprises at least one fiber selected from the group consisting of a natural fiber, a semi-synthetic fiber, and a synthetic fiber.

61. The method of claim 59, wherein the textile is arranged in accordance with a pre-determined pattern.

62. The method of claim 59, wherein the textile comprises a plurality of interweaving fibers.

63. The method of claim 57, wherein the pre-form comprises a porous material.

64. The method of claim 57, wherein the electrode composition comprises a cermet.

65. The method of claim 57, wherein the electrode composition comprises at least one selected from the group consisting of nickel, yttria-stabilized zirconia (“YSZ”), and a mixture of nickel and YSZ.

66. The method of claim 57, wherein the electrode composition further comprises a reforming catalyst.

67. The method of claim 57, further comprising coating the coated pre-form of step (a) with at least one other electrode composition.

68. The method of claim 67, wherein both the electrode composition and the at least one other electrode composition comprise a mixture of nickel and YSZ and wherein the content of YSZ of the at least one other electrode composition is higher than that of the electrode composition.

69. The method of claim 57, further comprising coating the electrode with at least one other electrode composition.

70. The method of claim 69, wherein both the electrode composition and the at least one other electrode composition comprise a mixture of nickel and YSZ and wherein the content of YSZ of the at least one other electrode composition is higher than that of the electrode composition.

71. The method of claim 57, further comprises coating the electrode with a high surface area coating material.

72. The method of claim 71, wherein the high surface area coating material is selected from the group consisting of gamma-alumina and a mixture of gamma-alumina and alpha-alumina.

73. The method of claim 71, wherein the high surface area coating material comprises a catalyst.

74. The method of claim 73, wherein the catalyst comprises a metal selected from the group consisting of platinum, palladium, rhodium, ruthenium, and iridium.

75. The method of claim 57, further comprises coating the pre-form with a catalyst composition before the step (a), wherein the catalyst composition catalyzes partial oxidation of a fuel.

76. The method of claim 57, further comprises coating the pre-form with a catalyst composition before the step (a), wherein the catalyst composition catalyzes combustion of a fuel.
